(19) United States
(12) Patent Application Publication
(10) Pub. No.: US 2007/0145135 A1
(43) Pub. Date: Jun. 28, 2007

(54) Methods used in a nested memory system with near field communications capability

(76) Inventors: Fabrice Jogand-Coulomb, San Carlos, CA (US); Yosi Pinto, Kfar Vradim (IL)

Correspondence Address: PARSONS HSUE & DE RUNTZ, LLP - SANDISK CORPORATION, 595 MARKET STREET, SUITE 1900, SAN FRANCISCO, CA, 94105, US

(21) Appl. No.: 11/321,833

(22) Filed: Dec. 28, 2005

(51) Int. Cl. G06K 7/08; G06K 19/06

(52) U.S. Cl. 235/451; 235/492

(57) ABSTRACT

A mass storage memory card adds functionality to host devices with which it is used. In addition to the ability to store large amounts of user files and protect them from unauthorized duplication, a mass storage device according to the present invention enables near field communications with a portable electronic device that otherwise does not have such functionality. In a preferred embodiment the mass storage device has a mother/daughter configuration wherein the daughter card is a fully functioning micro-SD card that can be used independently. The mother card can be accepted in an SD card slot and communicates via the SD protocol. Whether or not the daughter card is present in the mother card, a host with the mass storage device therein will be capable of near field communications. These communications can be peer to peer or can be used to purchase goods or services as a sort of electronic wallet. A controller of the device is also operable to coordinate, control, and safeguard the financial transactions made when using the device and host as an electronic wallet.

### CROSS REFERENCE TO RELATED APPLICATION

The present application is related to co-pending application to F. Coulomb and Y. Pinto, having attorney docket Number SNDK.394US1, and entitled “Nested Memory System With Near Field Communications Capability,” which application is incorporated herein in its entirety by this reference.

### FIELD OF THE INVENTION

The present application is related to portable flash memory based mass storage devices, security of data and applications within such devices, and radio frequency communications.

### BACKGROUND OF THE INVENTION

All documents, including but not limited to standards, papers and patents, referred to in any portion of this patent application, are incorporated by reference in their entireties, and are an intended to form integral part of the teachings of this document.

Electronic payment, and electronic commerce generally, are a great convenience to the user and the merchant alike. In addition to the electronic commerce over the Internet, payment can now be made with a radio frequency equipped card or portable device. One way of doing this is by utilizing near field communications (“NFC”). NFC allows payment by simply touching an NFC capable device to an NFC reader, or by putting the device within about ten to fifteen centimeters of the NFC reader. The close proximity requirement is necessary to avoid charging the wrong person or device.

Beyond using an NFC or “contactless” device on a contactless reader for payment of some other operation, two NFC devices can communicate with each other for any type of data transfer. The NFC technology can be also used to trigger Bluetooth connections. With two Bluetooth-enabled devices in close proximity, NFC can automatically initialize Bluetooth connectivity.

NFC technology is standardized in ISO 18092 and ISO 21481, ECMA 340, 352 and 356, and ETSI TS 102 190. NFC is also compatible with the broadly established “contactless” smart card infrastructure based on ISO 14443 A, which includes Philips MIFARE® technology, as well as Sony's FeliCa™ card.

ISO 14443 defines a proximity card used for identification that usually uses the standard credit card form factor defined by ISO 7810 ID-1. Other form factors also are possible, and as mentioned above, NFC technology has been integrated into devices such as a mobile telephone. NFC devices or cards use an embedded microcontroller (including its own microprocessor and several types of memory) and a magnetic loop (inductive) antenna that operates at 13.56 MHz (RFID). ISO14443 consists of four parts and describes two types of cards: type A and type B. The main differences between these types concern modulation methods, coding schemes (part 2) and protocol initialization procedures (part 3). Both type A and type B cards uses the same high-level protocol (so called T=CL) described in part 4. T=CL protocol specifies data block exchange and related mechanisms.

ISO 15693 is an ISO standard for “Vicinity Cards”, i.e. cards which can be read from a greater distance as compared to Proximity cards. ISO 15693 systems operate on 13.56 MHz frequency, and offer maximum read distance of 1-1.5 meters. An example of this being the Radio Identification tags (RFID) used to collect toll electronically. Vicinity cards can also be used to allow access to buildings or other corporate environments. Vicinity detection systems that function according to ISO 15693 (or similar protocols) can also be built into portable devices.

A commonly employed NFC chip or controller is produced by Phillips and is believed to have part number PN531. This NFC controller has three communications paths. The first is through the antenna, and is used for communication with an NFC reader or other NFC capable device. The second is a serial interface through a UART of the NFC controller. If the NFC controller is integrated in a device, this is the path that the device uses to communicate data to and from the NFC controller and the antenna coupled to it. The third path is via a two wire/pin serial connection known as the S²C connection or interface. Other NFC controllers and chips may have different connections and communications paths, and can also be used with the present invention, which will be described later.

Some currently available mobile telephones are capable of contactless communication. A few approaches are utilized for providing contactless communications within such telephones. In Japan, NFC (FeliCa™) functionality is provided in some mobile phones with an embedded secure controller and NFC chip, together with a permanent, dedicated NFC antenna built into the phone. This increases the cost of the phone for all consumers, including those who have no use for the NFC functionality, and is therefore an undesirable solution. Another approach is the so called “smart cover,” which incorporates the NFC chip, secure controller, and battery all in a replacement battery cover. When the user wishes to add contactless communication to his phone, he can purchase a new smart cover and swap out his old cover. This however, is quite an expensive option because the battery is a very costly component that contributes significantly to the cost and price of the cover, and it also results in the waste of perfectly good batteries when the old battery is replaced with the new smart cover. Furthermore, there is not interchangeability or universality with such an approach. Another solution is a phone that has the NFC chip and antenna built into the phone, but relies on a SIM card for the secure controller. Again, this approach results in a costlier phone for all consumers including those that have no use for the NFC functionality. In yet another solution, only the NFC antenna is built into the phone, and a SIM card used with the phone has both the secure controller and NFC chip. This again requires the antenna to be built into the phone and increases the cost of the phone. Also, the NFC capability is not universal, and cannot be added to any phone, only those having a built in NFC antenna.

The approaches utilizing a SIM card have other drawbacks. A SIM card is normally owned by the mobile network operator, not the owner of the phone or a 3^{rd} party. This makes it difficult for a 3^{rd} party to use the SIM card to provide functionality. For example, a bank wishing to provide an application to the phone would have to establish a relationship with every mobile phone operator used by its customers in order to use the SIM card as a vehicle for the application. This is extremely onerous if not impossible. It also means that the bank would have to share customer information, which may be confidential and proprietary, with the network operator. This has obvious implications with regard to privacy and to competition. Finally, the life cycle of the SIM card and the bank application would likely be different, and this makes providing and updating applications difficult, which further adds to the complications in the business relations between the bank, in this example, and the various mobile phone operators. Therefore, to date, there is not a satisfactory solution for easily adding contactless communication to portable devices not already having such built in hardware and functionality.

### SUMMARY OF THE INVENTION

The present invention allows contactless communication to seamlessly be added to a wide variety of devices. Any device having a slot for a small mass storage type memory card can be utilized for contactless communication due to the present invention. Examples of a small mass storage type memory card are the SD card, mini-SD card, micro-SD card, MMC card, Memory Stick, Memory Stick Duo, Compact Flash card, Smart Media card, and XD card. Any device also having a USB port and can also now be utilized for contactless communication with a portable thumb drive, or alternatively, a memory card that has a USB connection such as the SanDisk Ultra® II SD™ Plus Card according to the present invention.

When the card is taken out of the host device, the user can then place it in another device, therefore enabling multiple devices to utilize contactless communication. When the communication involves electronic commerce, the user's information and accounts can therefore also travel with the user from host device to device. In a preferred embodiment incorporating a mother/daughter card configuration, the daughter card is extremely small and can be utilized directly as a mass storage device or can be used together with the mother card as a mass storage device. The very small daughter card can be used in devices incapable of accepting a larger card, such as certain mobile telephones for example, whereas when it is used with the mother card, it can be used in another variety or class of devices. When used with the mother card, contactless operations are possible in addition to the typical mass storage functionality.

This mother daughter configuration allows for maximum flexibility for use in electronic commerce and identification. For example, the daughter card can be used in a number of differently configured mother cards. The same daughter card could be used in an SD card, a USB device, or a device specific type card. For example, a particular model of mobile phone may require a particular configuration of mother card due the geometry of the phone and placement of the mother card receptacle. In this case, the mother card may be a phone specific accessory to provide NFC or other functionality. The same may be true for any number of different host devices such as music players and digital cameras. With the mother/daughter configuration, the cost of the mother card can be reduced because the main mass storage memory is within the daughter card, and this reduces the cost of maintaining inventory of a variety mother cards. In certain embodiments, the antenna of the mother card may even telescope out from the main body of the mother card to facilitate contactless communication.

Other additional functionality such as a camera or GPS routines and maps can be provided with such a flexible mother/daughter combination.

### BRIEF DESCRIPTION OF THE DRAWINGS

FIG. 1A is an illustration of a standard SD card.

FIG. 1B is an illustration of mass storage device 100, according to an embodiment of the present invention.

FIG. 1C is an illustration of the functionality that mass storage device (“MSD”) 100 can add to a host device.

FIG. 1D is a schematic illustration of MSD 100 within a mobile or cellular telephone.

FIG. 2 is single mass storage controller, single card embodiment of MSD 100.

FIG. 3 is a schematic illustration of single card embodiment of MSD 100 having a first controller for mass storage and digital rights management and a second controller for financial transactions.

FIG. 4A is plan view of a standard micro-SD card also known as a TransFlash™ card.

FIG. 4B is plan view a micro-SD card equipped for use as daughter card in the present invention.

FIG. 5 is a schematic illustration of a mother/daughter card embodiment of MSD 100 utilizing a single mass storage memory controller.

FIG. 6A is a schematic illustration of a mother daughter card embodiment of MSD 100 utilizing a single mass storage memory controller incorporating NFC hardware and capability.

FIG. 6B is a schematic illustration of a mother daughter card embodiment of MSD 100 having a first controller for mass storage and digital rights management and a second controller for financial transactions.

FIG. 7 is a plan view illustrating the concept of MSD 100.

FIG. 8 is an illustration of MSD 100 as used with host 110.

FIG. 9 is a plan view of MSD 100 illustrating insertion and retraction of distal member 97.

### DETAILED DESCRIPTION OF THE PREFERRED EMBODIMENTS

Currently Available Memory Cards

In 1994 SanDisk Corporation, assignee of the present application, introduced the CompactFlash™ card (CF™ card) that is functionally compatible with the PC Card but is much smaller. The CF™ card is rectangularly shaped with dimensions of 42.8 mm. by 36.4 mm. and a thickness of 3.3 mm., and has a female pin connector along one edge. The CF™ card is widely used with cameras for the storage of still video data. A passive adapter card is available, in which the CF card fits, that then can be inserted into a PC Card slot of a host computer or other device. The controller within the CF card operates with the card's flash memory to provide an ATA interface at its connector. That is, a host with which a CF card is connected interfaces with the card as if it is a disk drive. Specifications for the CompactFlash card have been established by the CompactFlash Association, “CF+ and CompactFlash Specification Revision 2.0,” dated May 2003. An implementation of these specifications is described by SanDisk Corporation in a product manual “CompactFlash Memory Card Product Manual,” revision 10.1, dated September 2003.

The SmartMedia™ card is about one-third the size of a PC Card, having dimensions of 45.0 mm. by 37.0 mm. and is very thin at only 0.76 mm. thick. Contacts are provided in a defined pattern as areas on a surface of the card. Its specifications have been defined by the Solid State Floppy Disk Card (SSFDC) Forum, which began in 1996. It contains flash memory, particularly of the NAND type. The SmartMedia™ card is intended for use with portable electronic devices, particularly cameras and audio devices, for storing large amounts of data. A memory controller is included either in the host device or in an adapter card in another format such as one according to the PC Card standard. Physical and electrical specifications for the SmartMedia™ card have been issued by the SSFDC Forum.

Another non-volatile memory card is the MultiMediaCard (MMC™). The physical and electrical specifications for the MMC™ are given in “The MultiMediaCard System Specification” that is updated and published from time-to-time by the MultiMediaCard Association (MMCA), including version 3.1, dated June 2001. MMC products having varying storage capacity are currently available from SanDisk Corporation. The MMC card is rectangularly shaped with a size similar to that of a postage stamp. The card's dimensions are 32.0 mm. by 24.0 mm. and 1.4 mm. thick, with a row of electrical contacts on a surface of the card along a narrow edge that also contains a cut-off corner. These products are described in a “MultiMediaCard Product Manual,” Revision 5.2, dated March 2003, published by SanDisk Corporation. Certain aspects of the electrical operation of the MMC products are also described in U.S. Pat. No. 6,279,114 and in patent application Ser. No. 09/186,064, filed Nov. 4, 1998, both by applicants Thomas N. Toombs and M. Holtzman, and assigned to SanDisk Corporation. The physical card structure and a method of manufacturing it are described in U.S. Pat. No. 6,040,622, assigned to SanDisk Corporation.

A modified version of the MMC™ card is the later Secure Digital (SD) card. The SD Card has the same rectangular size as the MMC™ card but with an increased thickness (2.1 mm.) in order to accommodate an additional memory chip when that is desired. A primary difference between these two cards is the inclusion in the SD card of security features for its use to store proprietary data such as that of music. Another difference between them is that the SD Card includes additional-data contacts in order to enable faster data transfer between the card and a host. The other contacts of the SD Card are the same as those of the MMC™ card in order that sockets designed to accept the SD Card can also be made to accept the MMC™ card. A total of nine contacts are positioned along a short edge of the card that contains a cutoff corner. This is described in patent application Ser. No. 09/641,023, filed by Cedar et al. on Aug. 17, 2000, International Publication Number WO 02/15020. The electrical interface with the SD card is further made to be, for the most part, backward compatible with the MMC™ card, in order that few changes to the operation of the host need be made in order to accommodate both types of cards. Complete specifications for the SD card are available to member companies from the SD Association (SDA). A public document describing the physical and some electrical characteristics of the SD Card is available from the SDA: “Simplified Version of: Part 1 Physical Layer Specification Version 1.01,” dated Apr. 15, 2001.

More recently, a miniSD card has been specified by the SDA and is commercially available. This card is smaller than the SD card but provides much of the same functionality. It has a modified rectangular shape with dimensions of 21.5 mm. long, 20.0 mm. wide and 1.4 mm. thick. A total of eleven electrical contacts are positioned in a row on a surface of the card along one edge. The miniSD memory card is available from SanDisk Corporation and described in the “SanDisk miniSD Card Product Manual,” version 1.0, April 2003.

A different type of card is the Subscriber Identity Module (SIM), the specifications of which are published by the European Telecommunications Standards Institute (ETSI). A portion of these specifications appear as GSM 11.11, a recent version being technical specification ETSI TS 100 977 V8.3.0 (2000-08), entitled “Digital Cellular Telecommunications System (Phase 2+); Specification of the Subscriber Identity Module-Mobile Equipment (SIM-ME) Interface,” (GSM 11.11 Version 8.3.0 Release 1999). Two types of SIM cards are specified: ID-1 SIM and Plug-in SIM.

The ID-1 SIM card has a format and layout according to the ISO/EEC 7810 and 7816 standards of the International Organization for Standardization (ISO) and the International Electrotechnical Commission (EEC). The ISO/EEC 7810 standard is entitled “Identification cards—Physical characteristics,”second edition, August 1995. The ISO/IEC 7816 standard has the general title of “Identification cards—Integrated Circuit(s) Cards with Contacts,” and consists of parts 1-10 that carry individual dates from 1994 through 2000. Copies of these standards are available from the ISO/IEC in Geneva, Switzerland. The ID-1 SIM card is generally the size of a credit card, having dimensions of 85.60 mm. by 53.98 mm., with rounder corners, and a thickness of 0.76 mm. Such a card may have only memory or may also include a microprocessor, the latter often being referred to as a “Smart Card.” One application of a Smart Card is as a debit card where an initial credit balance is decreased every time it is used to purchase a product or a service.

The Plug-in SIM is a very small card, smaller than the MMC™ and SD cards. The GSM 11.11 specification referenced above calls for this card to be a rectangle 25 mm. by 15 mm., with one corner cut off for orientation, and with the same thickness as the ID-1 SIM card. A primary use of the Plug-in SIM card is in mobile telephones and other devices for security against the theft and/or unauthorized use of the devices, in which case the card stores a security code personal to the device's owner or user. In both types of SIM cards, eight electrical contacts (but with as few as five being used) are specified in the ISO/IEC 7816 standard to be arranged on a surface of the card for contact by a host receptacle.

Sony Corporation has developed and commercialized a non-volatile memory card, sold as the Memory Stick™, that has yet another set of specifications. Its shape is that of an elongated rectangle having 10 electrical contacts in a row and individually recessed into a surface adjacent one of its short sides that also contains a cut out corner for orientation. The card's size is 50.0 mm. long by 21.5 mm. wide by 2.8 mm. thick.

A more recent Memory Stick Duo card is smaller, having dimensions of 31.0 mm. long by 20.0 mm. wide by 1.6 mm. thick. Ten contacts are provided in a common recess in a surface and along a short side of the card, which also contains an orienting notch. This smaller card is often used by insertion into a passive adapter having the shape of a Memory Stick card.

SanDisk Corporation has introduced an even smaller transportable non-volatile micro-SD card also known as the TransFlash memory module, in a modified rectangular shape, having dimensions of 15.0 mm. long by 11.0 mm. wide by 1.0 mm. thick. Eight electrical contact pads are provided in a row on a surface adjacent a short edge of the card. This card is useful for a variety of applications, particularly with portable devices, and is being incorporated into multimedia camera cell telephones.

As is apparent from the foregoing summary of the primary electronic card standards, there are many differences in their physical characteristics including size and shape, in the number, arrangement and structure of electrical contacts and in the electrical interface with a host system through those contacts when the card is connected with a host. Electronic devices that use electronic cards are usually made to work with only one type of card. Adaptors, both active and passive types, have been provided or proposed to allow some degree of interchangeability of electronic cards among such host devices. U.S. Pat. No. 6,266,724 of Harari et al. describes use of combinations of mother and daughter memory cards.

Small, hand-held re-programmable non-volatile memories have also been made to interface with a computer or other type of host through a Universal Serial Bus (USB) connector. These are especially convenient for users who have one or more USB connectors available on the front of their personal computers, particularly if a receptacle slot for one of the above identified memory cards is not present. Such devices are also very useful for transferring data between various host systems that have USB receptacles, including portable devices. Mechanical and electrical details of the USB interface are provided by the “Universal Serial Bus Specification,” revision 2.0, dated Apr. 27, 2000. There are several USB flash drive products commercially available from SanDisk Corporation under its trademark Cruzer. USB flash drives are typically larger and shaped differently than the memory cards described above.

Some of the devices described above are mass storage devices, and some are not. In particular, the SIM and smart cards are not mass storage cards because they not capable of storing any substantial amount of data. They do not have the memory capacity, and more importantly they were never meant to store more than a small amount of data relating to a user's identification and transactions. It is not just an issue of memory capacity. The controllers in the SIM cards are not equipped to frequently read and write the relatively massive amounts of data, for instance, of a digital photo or song. Nor do they typically have the digital rights management routines that limit the access to copyrighted or otherwise limited access content to only authorized users.

Use of the Cards and Other Mass Storage Devices

The micro-SD card is extremely small. For reference, the micro-SD card has a footprint much smaller than a U.S. ten cent coin, also known as a dime. In fact, it can be placed upon a dime with room to spare. It is already available with hundreds of times the capacity of floppy disks, and is therefore a very convenient way to store and transport volumes of data. The micro-SD card will be especially useful in portable or handheld mobile devices such as telephones, music players, cameras, digital organizers or all in one devices that combine some or all of the functions into one device.

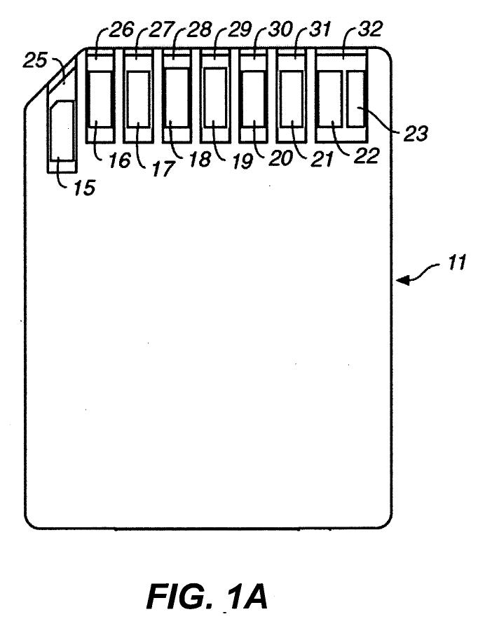

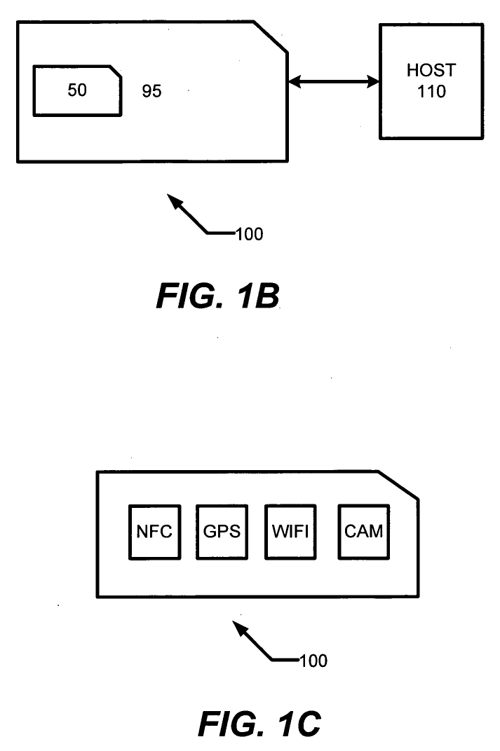

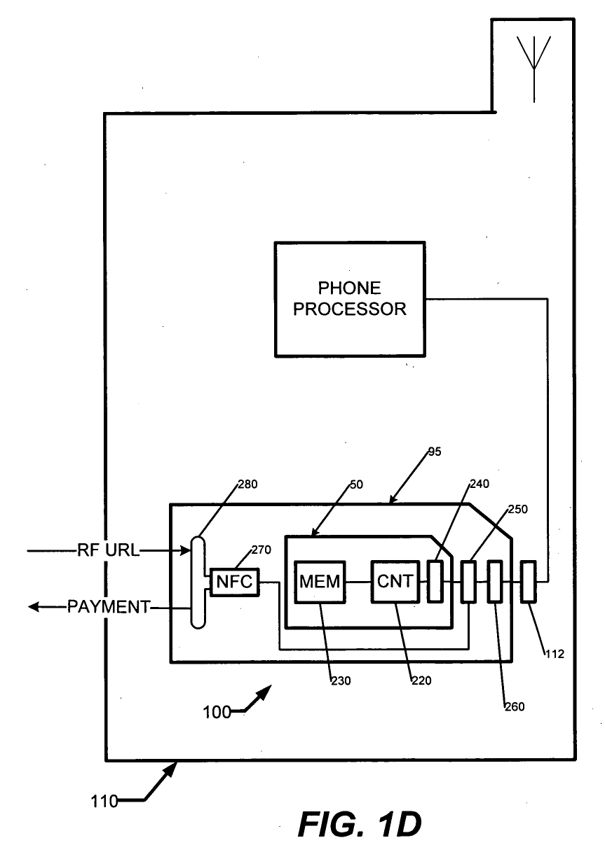

Referring to FIG. 1A, a standard mass storage memory card 11, in this case the SD card, is shown. Although any of the mass storage memory cards, as well as the portable USB flash drives can be used in the present invention, the use of the SD card and/or card bus is preferred and will be described in detail. According to the SD Memory Card Specifications, nine electrical contacts 15-23 are provided on bottom surfaces of recesses 25-32 in the plastic housing of the card 11, the two contacts 22 and 23 being placed in the one recess 32. The card is 24 mm. by 32 mm. in size with a thickness 35 of 2.1 mm. This card is backwards compatible with the MMC card and will fill into any device accepting an MMC card. Many different portable devices currently accept the SD and MMC cards and have the associated SD card slot. Long popular as the card of choice for PDA's, the SD card is also now utilized by a wide array of digital cameras and music players, because of the copyright management (“CPRM”) integrated into the cards. Because of the small size of the card, they are also frequently used in many types of mobile telephones.

With the present invention, these cards will add functionality, above and beyond the mass storage ability present in a standard SD card, to devices that otherwise lack the functionality. As discussed in the background, this is advantageous to manufacturers and consumers alike, because it allows the user to tailor the functionality of his device to his own needs and tastes, rather than integrating some predetermined functionality that not every user wants or needs into the device. This keeps the cost of the basic device down, and provides a greater level of flexibility over time.

As seen in FIG. 1B, mass storage device (“MSD”) 100 will be used with host device 110. Device 100 will have the form factor of a memory card (or USB device, as mentioned previously), preferably, an SD card like SD card 11. While this is generally true, the form factor can deviate from the standard version of the memory card, so long as the card will fit into its intended receptacle and still communicate using the associated card standard or protocol. More specifically, some portion of device 100 may extend out of the slot of host 110, although the device will still be physically and logically compatible with the slot and the host. Host 110 can be any electronic device with a slot or receptacle for accepting device 100, many examples of which were previously described.

Device 100 can add any range of functionality to the host 110. While preferably, device 100 comprises a card within a card structure, embodiments utilizing only a single card (or body in the case of a USB “thumb” drive) are also encompassed by the present invention. For purposes of this application, the larger of the cards will be referred to as the mother card, and the smaller of the cards will be referred to as the daughter card. As seen in FIG. 1B, daughter card 50 fits within mother card 95. The functionality and hardware of device 100 will be distributed differently between daughter card 50 and mother card 95 depending on the end use of device 100, and some examples of the distribution and connectivity will be described later. Mother card 95, may also be referred to as an adapter, but unlike other currently available adapters, it is preferably not simply an adapter for making a small card fit into a larger card receptacle, but contributes to the overall functionality added by device 100.

FIG. 1C illustrates some examples of the functionality that device 100 can add to host device 110. MSD 100 can add near field communications (proximity and/or vicinity) technology to any host 110. This means that, for example, a user could use his mobile telephone to pay for any item he wants, by touching or putting the phone near to a payment receiver or other “smart poster” that allows a person to pay for an advertised good or service in the poster. This will be discussed more later with regard to FIG. 1D. Another interesting use of the device would be for instantly buying a plane or train ticket and for boarding a train or plane after that. It also means, that a user, could use the same phone to enter his office building or any other location where a wallet sized access card is typically utilized. While the phone is used as an example because a person rarely goes anywhere without his phone, as mentioned previously, the host could be any electronic device with the proper slot/receptacle.

GPS functionality and the maps associated with the GPS could also be added to a user's device. In such a case, all or some of the circuitry and routines necessary to enable GPS communication would be included in device 100. Of course, coordination of the functionality with the host device 100 will typically be important in most scenarios and is achieved via communications with the processor of the host device.

Wireless local area networks (“LANs”) can also be accessed with device 100. This is more commonly referred to typically as WiFi. As discussed in the background, WiFi is governed by the 802.11x guidelines at the moment. Other radio frequency (“RF”) transmission can also be included, including Bluetooth etc. In many RF applications, an antenna of device 100 will be positioned so that it will extend out from host device 110 and may also translate into or out of some portion of MSD 100.

In addition, a camera can be added to a host device via portable device 100. While it has been possible for some time now to add a camera to mobile phones and other devices, those cameras have been device specific. This is mainly true because the processor of the phone had to directly control the camera. In device 100, a controller of the device can control the camera, and interface with a wide variety of host devices 110 through a simple application programming interface (“API”). Therefore, camera adapter of device 100 could be easily interchangeable with many different types of host a user may already have. For instance, the user could swap the camera from his PDA to his phone to his laptop or his mp3 player simply by inserting and removing the device from the host.

Preferably, the hardware required to provide the added functionality is contained in mother card 95. In such a way, the daughter card, usable directly in different host devices, with all of the user files and data therein, can easily be inserted into and removed from the mother card 95 without removing all of the functionality of MSD 100. Although all the functionality can be contained in the daughter card 95 as well, or as mentioned previously in a one card (non mother-daughter) embodiment, it is currently preferred to have much of the functionality specific hardware in the mother card 95.

It is important to note that while portion 95 is often referred to as a mother card, in some (but not all) embodiments it will lack the memory controller, and rely on the memory controller in the daughter card 50 for data storage and security. In such embodiments, this is not to say that it does not have a processor or other type of controller for other purposes, .e.g. a communications or other controller. However, the most common embodiments will rely on the controller of daughter card 50 in order to cut down on the cost of mother card 95 and the overall cost of device 100. This is also advantageous because, as mentioned previously, daughter card 50 can function as a stand alone mass storage memory card that can be used directly with any number of hosts. Even in embodiments where the mother card 95 does not have a memory controller, the mother card 95 will function without the daughter card. This means that the added functionality provided by device 100 will be usable by the host device whether or not the daughter card 50 is inserted. In embodiments of device 100 where the mother card lacks mass storage functionality on its own right, this mass storage functionality will be the only thing lacking when the mother card is used alone.

It is envisioned that the smaller daughter card may be accepted in a range of products different than the mother card 95 and the overall device 100, although of course, some amount of overlap will almost certainly be present. For instance, this is advantageous because while the daughter card may be accepted by certain small mobile phones, there may not be a slot for such a daughter card in a laptop computer or a digital television, for example. In such a case, the data on the daughter card can still easily be accessed by inserting the mother/daughter combination into the laptop computer or digital television.

FIG. 1D illustrates device 100 in one possible environment, that of a mobile telephone type of host 110. The present invention is especially useful in such an environment and will be described in such an environment from this point forward, although it should be well understood that this is only one of many possible hosts and environments.

A user of a mobile phone typically carries his phone more than any other electronic device at his disposal. This makes for a convenient platform in which to add functionality. One especially useful function to add to the phone is RF communications, especially near field communications, as described in the background. A host 110 capable of near field communications (via mass storage device 100) can communicate directly with another NFC enabled device. This could be a reader or another device in what is known as peer to peer communication. This happens through antenna 280 in MSD 100. It does not happen via the built in antenna of the telephone. This is because an NFC capable antenna is of a different design than the long range antenna in the telephone. Generally speaking, an NFC antenna is not capable of transmitting the long range signals needed to communicate with cellular telephone transmitters, and conversely, the long range antenna of the phone is not suitable for NFC communication, although there may be some exceptions. Although some design comprises might be made to use one single dual purpose antenna, at present it is believed that one dual purpose antenna would perform poorly at either task. Furthermore, it is undesirable for MSD 100 to use the antenna of the phone for NFC because of the variances (parasitic characteristics etc.) in the antenna from phone to phone. This is all to say that the NFC capability is provided by MSD 100 and relies on the antenna 280 of the MSD.

One interesting application for NFC communication is payment. With MSD 100 inserted into a phone, one could use the phone to pay for any range of goods and services, via the MSD. In order to do so, the user would place his phone within the NFC range, which is about 10-15 centimeters, although typically the user may actually touch the phone to an NFC enabled device. Any kind of cash register, or electronic device for that matter, could be NFC equipped. As an example, a type of advertisement known as a “smart poster” has been developed. This smart poster would allow a person with an NFC equipped phone to pay for whatever is advertised on the face of the poster by putting his phone within NFC range of the poster. In such a case, a radio frequency universal resource locator (“RF URL”) is transmitted from the poster to the antenna 280 of MSD 100. Once the good or service is purchased, a signal indicating payment is then transmitted from the MSD back to the poster. The payment details are kept secure within the memory 230 of MSD 100. User input may be provided through the user interface of the phone and would be coordinated with the phone processor. More specifically, a controller of MSD 100 would coordinate such transactions with the processor of the telephone. Alternatively, all of the transaction can be handled by a controller of MSD 100. In either case, the phone could be used to display details of the transaction, regardless of how the transaction was conducted.

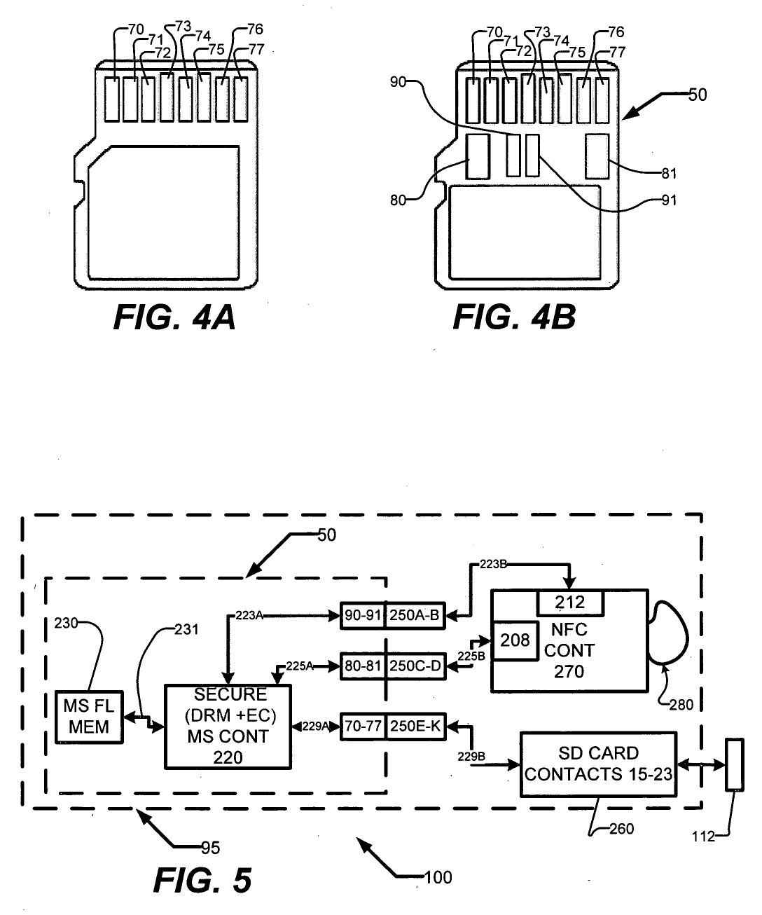

Shown in FIG. 1D is the mother/daughter embodiment of device 100, although the one piece embodiment could be utilized. Within mother card 95 is the short range antenna 280 and NFC controller or “chip” 270. Also within mother card 95 are two sets of contacts, internal contacts 250 for communicating with daughter card 50 and external contacts 260 for communicating with host device 110. In the preferred case where the mother card has the form factor of an SD card as shown in FIG. 1A, the set of external contacts 260 would comprise contacts 15-23 as in an SD card shown. The internal set of contacts 250 are part of a receptacle within the mother card 95 for accepting and communicating with the daughter card 50, and as such will vary depending on the type of daughter card. In the preferred case, the daughter card is a type of micro-SD card and the contacts will be as shown and described later with regard to FIG. 4B. NFC chip 270 is coupled to one or more of the internal set of contacts 250. Host device 110 has a receptacle with a group of contacts 112. When MSD 100 is inserted into host 110, host contacts 112 make electrical contact with mother card external contacts 260, which are intern coupled with some or all of mother card internal contacts 250, intern coupled to daughter card contacts 240 when the daughter card 50 is within a receptacle of mother card 95. Within daughter card 50, daughter card contacts 240 are coupled via a bus to controller 220. Controller 220 controls the read/write operations of the flash memory 230. Controller 220 includes security precautions that limit access to content in flash memory 230, and provides the security to overall MSD 100.

A larger sized but backward compatible SIM card is also currently being developed. It is envisioned that a version of the micro-SD card may be used as a daughter card in this larger sized SIM, which is also referred to as a mega- or super SIM.

For purposes of this application an NFC capable device or NFC chip is capable of both vicinity and proximity range communications under ISO/IEC 14443PCD mode and ISO/IEC 15693VCD mode.

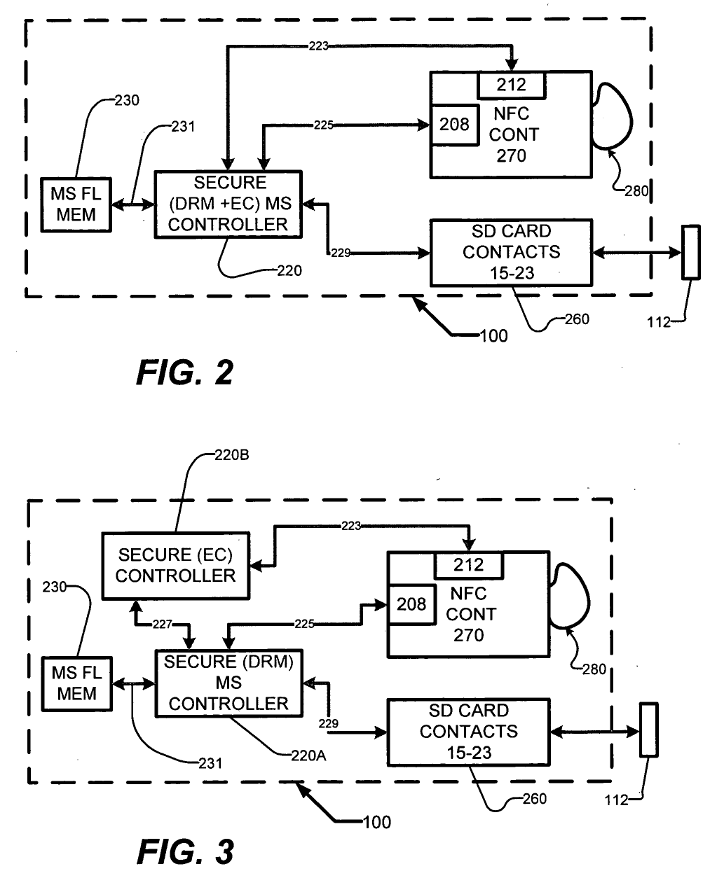

FIG. 2 illustrates a first embodiment of MSD 100. This is a single piece embodiment, rather than a mother/daughter embodiment. There are two communications paths to/from MSD 100. The first is to and from host 110 via the card contacts 260. This can be referred to as wired communication. The external card contacts 260 are connected to host device contacts 112. The second is an RF path to/from an NFC enabled device via NFC controller chip 270 and NFC antenna 280. One example of a currently available NFC chip is Phillips part No. 531 or 511. NFC controller (“NFCC”) 270 has two interfaces, one for data, and one for configuration. The data interface is transceiver or “UART” 208, where data is sent to and from controller 220 via data lines 225. These communications can be of a proprietary nature or according to SDA or other protocol. The configuration interface 212 is connected to controller 220 via one ore more configuration lines 223. In the example NFC from Phillips, configuration can be accomplished with Phillips S²C protocol which is a two wire solution. Other single wire solutions are currently available from Axalto. Other versions of NFCC 270 may have a different configuration for communication and configuration.

As can be seen, controller 220 is at the heart of MSD 100. Controller 220 controls reading and writing of data to/from the mass storage flash memory 230, and in turn controls communication to/from MSD 100 to host device 110, and to/from a second NFC enabled device (not shown) via NFCC 270. As such, it also is responsible for the security of MSD 100.

Controller 220 is a secure controller capable of copy protection of user content such as copyrighted works as well as secure data relating to commercial (“EC”) transactions. Protection of copyrighted or other content is sometimes referred to as CPRM or also one well known implementation of copy protection known as digital rights management (“DRM”). DRM when used in this application shall have the broad meaning of a scheme for limiting access to user content/files such as those that contain copyrighted or other material that is deemed worthy of copy protection. One of the security mechanisms of secure controller 220 is encryption. Data stored in mass storage memory 230 is encrypted, and data transmitted to and from MSD 100 may also be encrypted. The encryption techniques can be implemented in software or hardware, or a combination of the two. For more information on the security provided by controller 220 please refer to the following patents and patent applications, each of which is hereby incorporated by this reference it its entirety: co-pending patent application Ser. No. ______, entitled “Secure Memory Card with Life Cycle Phases” to M. Holtzman et al., Attorney Docket No. SNDK.383US3; co-pending patent application Ser. No. ______, having attorney docket number SNDK.382US4, and entitled “Control Structure for Versatile Content Control,” to Fabrice Jogand-Coulomb et al; and published patent application No. 20020176575 entitled “System, method, and device for playing back recorded audio, video or other content from non-volatile memory cards, compact disks or other media” to Qawami et al.

In the case of financial transactions, in order to be accepted by the financial community as being sufficiently secure and robust, controller 220 is preferably certified or approved by a well accepted certifying body. For instance, the Smart Card has such a controller that is certified. Controllers for smart cards are well known in the industry, and one example is referred to as an SMX controller, also from Philips. It is preferred have one single controller 220 that is certified (or otherwise well accepted) for financial transactions, as well as for DRM, as is shown in FIG. 2. If this is not the case, two separate controllers may be utilized, as will be described below.

FIG. 3 illustrates a one card, two controller embodiment of MSD 100. In such an embodiment, a first controller 220A controls the reading and writing of data to and from the flash memory and also contains the DRM functionality, but coordinates operations relating to financial transactions with a second controller 220B. This would be the implementation where, for example, controller 220A was not certified or otherwise sufficiently well accepted for financial transactions or electronic commerce whereas controller 220B was. An example of controller 220B is the Philips SMX controller, which although certified for financial transactions does not control the read/write operations of mass storage memory 230, including the copy protection management referred to herein as DRM. Communications between the two controllers 220A and 220B is over controller link 227 according to the ISO 7816 standard/protocol. This communication can alternatively be accomplished with proprietary communications or with a newly developed protocol of the SDA defined in the Mobile Commerce Extension Specification. For further information on this please refer to the micro-SD specification “SD Specifications, Part A1, Mobile Commerce Extension Specification, Version 1.00, February, 2004” available from the SD Association.

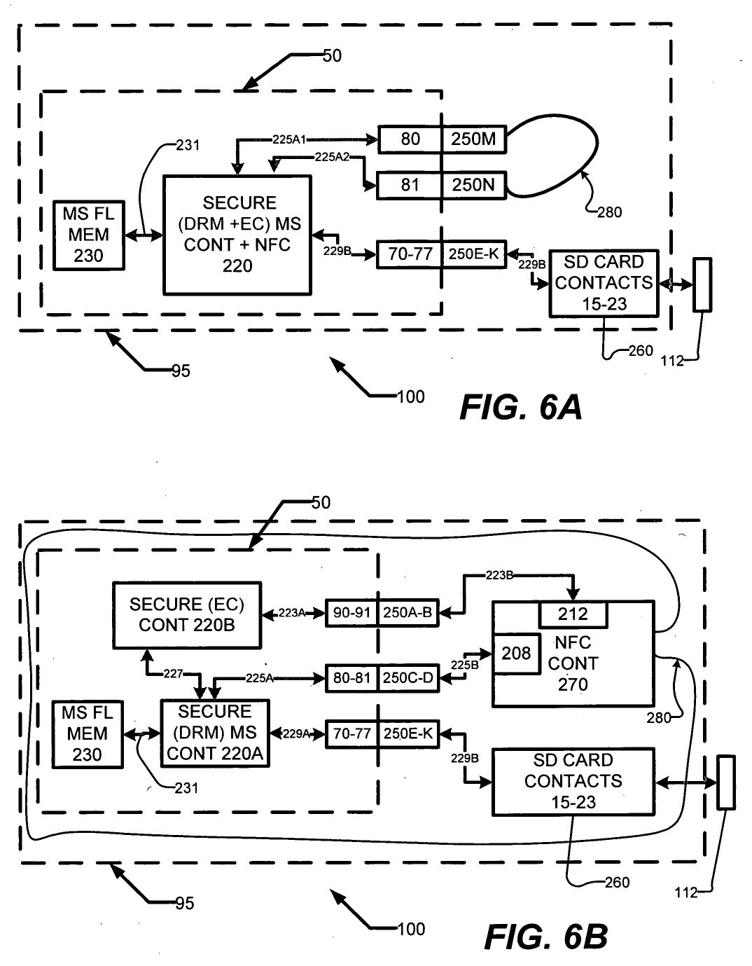

FIGS. 5, 6A, and 6B illustrate mother/daughter embodiments of MSD 100. The daughter card is preferably a mini-SD card or a micro-SD card, which is also known by its trademark name of the TransFlash™ card. Usage of a micro-SD card is shown in FIGS. 5, 6A and 6B will now be described. First, the standard micro-SD card is shown in FIG. 4A. Contacts 70-77 are used to communicate data according to the SD protocol. For further information on this please refer to documents entitled: “SD memory card specification, Part 1, physical layer specification ver. 1.0;” and “SD Specifications, Part A1, Mobile Commerce Extension Specification, Version 1.00, February, 2004” available from the SD Association. Other documents of interest may also be available from the SD Association.

The micro-SD card shown in FIG. 4A, when used as a daughter card in MSD 100, is not equipped to communicate with the NFCC. All of contacts 70-77 are utilized for communication and operation with a host device, as can be seen in the SD specification. To be used as a daughter card in an NFC enabled mother daughter combination, additional contacts have to be provided to communicate with the NFC hardware in the mother card. One example of a microSD card comprising the additional contacts for such operation is shown in FIG. 4B. Additional contacts 80 and 81 are used to communicate data to/from the UART 208 of NFCC 270. Additional contacts 90-91 are used to configure NFCC 270 via configuration interface 212 of the device. As mentioned previously, a single wire connection 223 can also be utilized to configure NFCC 270. In such a case, only one of contacts 90 or 91 would be necessary and present on daughter card 50 shown in FIG. 4B. Also, the arrangement and position of the contacts 80-81 and 90-91 may differ from that illustrated. It should be noted that the addition of contacts 80-81 and 90-91 in no way affects the compatibility of the microSD card with slots or receptacles designed to receive it. A slot or receptacle designed to work with the standard micro-SD card seen in FIG. 4A will accept daughter card 50 of FIG. 4B and utilize the standard contacts 70-77 just as it would the standard micro-SD card.

FIG. 5 shows the single controller 220 within daughter card 50. The signals used to configure NFCC 270 pass through contacts 90-91 of daughter card 50. They make a connection with contacts 250A-B of mother card 95, which are coupled to configuration interface 212 via configuration lines 223B. Data communication from the daughter card memory controller 220 to the NFCC in the mother card is through contacts 80-81 of daughter card 50. The communication lines 225 are now in two parts: 225A within the daughter card and 225B within the mother card. Communication to (contacts 112 of) host 110 from the daughter card memory controller 220 goes via the mother card SD contacts 260. Mother card contacts 260 are connected to the memory controller 220 though daughter card contacts 70-77 which are coupled to mother card internal contacts 250E-K.

FIG. 6A illustrates an embodiment of MSD 100 which is a mother/daughter combination where the NFC capability is directly integrated into controller 220. Controller 220 therefore controls DRM, EC, and NFC. In this case, contacts 80 and 81 of the daughter card that are used for RF/NFC communication are connected to antenna 280 in mother card 95 via contacts 250M and 250N of contacts 250, as there is no longer an NFC chip within mother card 95. This can also be implemented in a one piece version (not shown) rather than a mother/daughter configuration.

Finally, FIG. 6B shows a two controller mother/daughter embodiment of MSD 100. As in the embodiment shown in FIG. 3, controller 220A and 220B communicate via ISO 7816 or SDA protocol/standards. The EC controller 220B configures the NFCC 270 while mass storage memory controller 220A with DRM manages data storage and wireless and wired communications. As discussed previously, wireless near field communication takes place via NFCC 270 and antenna 280, whereas wired communications utilize the mother card contacts 260, which in the case of an SD card are SD card contacts 15-23.

Although an NFC controller 270 and antenna 280 have been described, any RF transmitter and controller can alternatively be implemented, including those for longer range wireless LAN (802.11) communication known as WiFi. The present invention is not limited to NFC range communications and the frequencies involved. Any radio frequencies can be utilized, and antennas tuned for different ranges and frequencies can be utilized. Therefore, it should be understood that the near field communications controller 270 described would also be capable of other RF communications.

Another embodiment of the invention not shown in the figures involves a mother card with a memory controller (such as controller 220) and a daughter card also having a memory controller (such as controller 220). Because each controller (220) is in charge of data storage operations in the mass storage flash memory (230 in the figures) there must be a way to coordinate the operation of both controllers when the daughter card is in the mother card. One way is for all communications with the host to be routed through the mother card controller. An application running in the mother card would then determine the nature of the incoming command type. If the command is a storage type command it would then transmit the command and associated data to the daughter card and its controller. If the command is not a storage type command the command would be communicated to and handled by another application running in the mother card.

A second way is to route incoming communications from a host through a type of hardware based dispatcher in the card before the communication goes to the mother card controller. In this second way, the dispatcher assesses the command type and sends the command and associated data to either the mother card controller or to the daughter card and its controller.

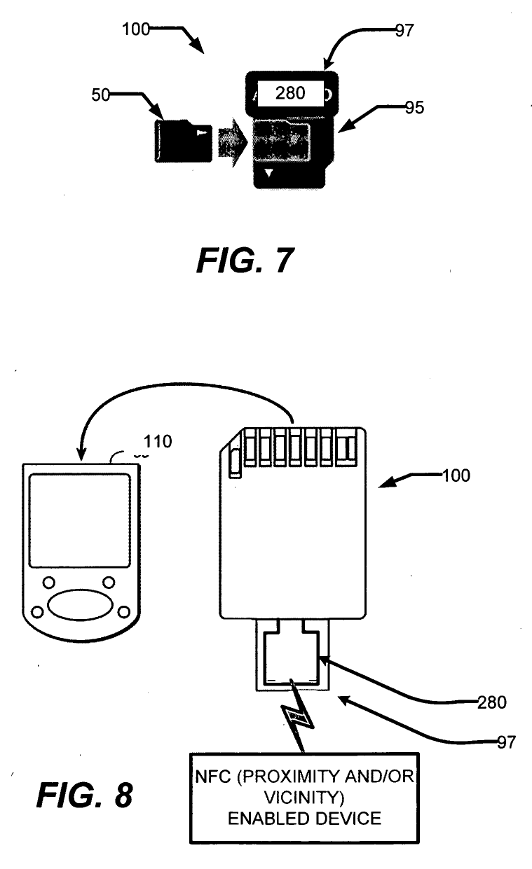

FIG. 7 illustrates the daughter card 50 to be inserted into mother card 95. On the end of mother card 95 is a distal member 97 that would stick out of a host device when MSD 100 is inserted into the receptacle/slot of the host. This distal member 97 is where antenna 280 will be located in some embodiments of MSD 100. In other embodiments antenna 280 will be contained within the standard form factor for the given type of memory card. Putting the antenna in this distal, protruding member 280 provides for a clearer communication path with the device with which MSD 100 will be communicating, whether it is a reader or another device capable of wireless or “contactless” communication. FIG. 8 illustrates MSD 100 as it would be inserted into a PDA type of host 110, with where distal member 97 would protrude from the housing of the PDA to facilitate NFC or other RF communication using the PDA. In embodiments of MSD 100 where a camera would be provided, the camera would be contained on this distal member 97. In such an arrangement, the distal member 97 can have different geometries and sizes depending on the nature of the host. For example, an antenna suitable for GPS communication could provided on/in the distal member. GPS functionality would then be provided by an application running in the card controller and/or the host device processor.

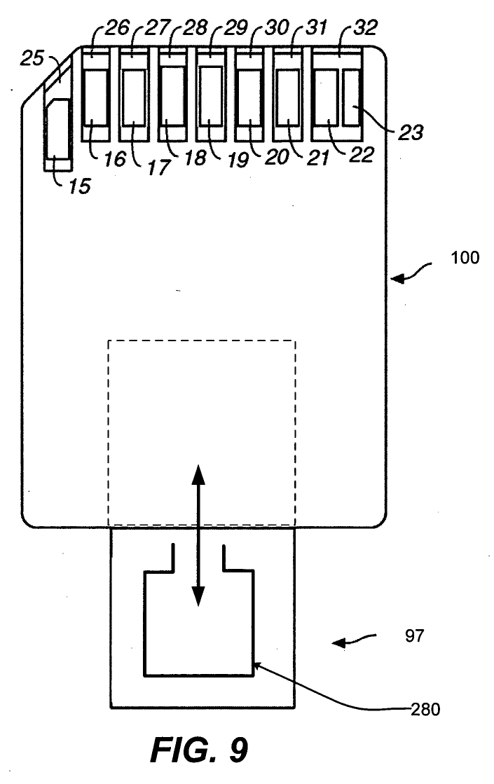

In certain embodiments, the distal member can be inserted into the body of MSD 100 when it is not being used or if it is otherwise desirable to leave it within the body of MSD 100 for some other reason, as can be seen in FIG. 9. Different configurations of the member could be implemented to make it suitable for use with a variety of different host devices and with different mother/daughter combinations.

It is claimed:

1. A method of expanding the functionality of a portable electronic device to include near field communications, the method comprising:
providing a mass storage memory card comprising a near field communications controller and a near field communications antenna,
said near field communications controller coupled to a controller of the memory card,
said memory card removably coupled to the portable electronic device, and in communication with a processor of the electronic device.

2. A method of expanding the functionality of a portable electronic device to include near field communications, the method comprising:
providing an SD compatible card comprising a near field communications controller and a near field communications antenna,
said near field communications controller coupled to a controller of the SD compatible card,
said SD compatible card removably connectable with the portable electronic device at an SD receptacle of the electronic device, and in communication with a processor of the electronic device.

3. A method of expanding the functionality of a portable electronic device to include near field communications, the method comprising:
providing a first mass storage memory card comprising a memory controller; and
providing a module comprising a near field communications controller and an antenna, the module having the form factor of a second mass storage memory card,
the module having a recess that accepts the first mass storage memory card such that the first mass storage device fits in the recess and within the form factor of the of the second mass storage memory card,
the module and first mass storage memory card insertable in a slot of the electronic device.

4. A method of expanding the functionality of a portable electronic device to include short range communications, the method comprising:
providing a first mass storage memory card comprising a memory controller,
said memory controller comprising a radio frequency transceiver; and
providing a module comprising a short range antenna, the module having the form factor of a second mass storage memory card,
the module having a recess that accepts the first mass storage memory card such that the first mass storage device fits in the recess and within the form factor of the second mass storage memory card,
the transceiver within the first mass storage memory card coupled to the short range antenna within the module, the module having the form factor of a second mass storage memory card,
the module and first mass storage memory card therein, insertable together into a slot of the electronic device.

5. The method of claim 4, wherein the form factor of the first mass storage memory card is a micro-SD card form factor.

6. The method of claim 4, wherein the form factor of the module is an SD card form factor.

7. The method of claim 4, wherein the form factor of the module is one of: a MiniSD format, Memory Stick format, Memory Stick duo format, a compact flash card format, or an XD card format.

8. The method of claim 5, wherein providing a first mass storage memory card further comprises providing one or more contacts used for communicating with radio frequencies via the short range antenna, said one or more contacts provided in addition to a plurality of contacts utilized for wired data transfer if the first mass storage memory card were to be placed directly into an electronic device without the module.

9. A method of enabling near field communications in a portable electronic device having a slot for receiving a memory card, the method comprising:
providing a memory card that fits into the slot of the electronic device,
the memory card operable to store and retrieve user files and having digital rights management routines operable to protect copyrighted content on the card from unauthorized duplication,
the memory card also operable to safeguard transactional data used in commerce;
providing a near field communications circuit within the memory card; and
providing a near field antenna within the memory card.

10. The method of claim 9, further comprising providing a movable element within the memory card, a portion of said element extending a distance away from a body of the card.

11. The method of claim 9, wherein the near field antenna is provided on or within the movable element, and wherein the element is extended to enhance near field communications.

12. A method of making a payment using a mobile telephone, the method comprising:
inserting a mass storage memory card having an antenna of a shorter range than the antenna of the mobile telephone into a receptacle of the mobile telephone;
receiving a signal associated with an available good or service with the mass storage memory card;
making the payment for the available good or service with the telephone by sending a signal from the mass storage memory card.

13. The method of claim 12, wherein the signal associated with the good or service comprises information regarding a radio frequency universal resource locator.
